(19) United States
(12) Patent Application Publication
(10) Pub. No.: US 2014/0040193 A1
(43) Pub. Date: Feb. 6, 2014

(54) COMPUTER AND NETWORK PROCESSING OF SECURITY SPREAD DATA

(71) Applicant: John George Bruce McLean, Toronto (CA)

(72) Inventor: John George Bruce McLean, Toronto (CA)

(73) Assignee: FTSE TMX GLOBAL DEBT CAPITAL MARKETS INC., Toronto, ON (CA)

(21) Appl. No.: 14/006,475

(22) PCT Filed: Jul. 31, 2012
(86) PCT No.: PCT/CA12/00715

§ 371 Date: Oct. 17, 2013

(51) Int. Cl. G06F 17/30

(52) U.S. Cl. CPC G06F 17/30575
USPC 707/610; 707/609

(57) ABSTRACT

Computers, computer systems, and methods can be configured to receive selection of a security data record set, receive selection of an input date, determine for the input date a benchmark yield spread of the security data record set with reference to a benchmark security, and determine for a date of last trade a last trade yield spread of the security data record set with reference to the benchmark security. This may be performed over one or more networks using one or more servers or client computers, which may be provided with a value line, or other user-interface control, to select the input date and a display element to display the benchmark yield spread and the last trade yield spread.

### TECHNICAL FIELD

This disclosure relates to computers and, more specifically, to data processing using computers.

### BACKGROUND ART

Financial data, such daily as prices, yields, and trade volumes of securities, can consume large amounts of computer resources in the form of storage and network traffic.

Many financial securities are traded in many different markets. Saving records of these trades can require a substantial amount of computer storage space. Care should also be taken to not unnecessarily duplicate data.

Communicating current and historical trade data can require a significant amount of network capacity, particularly if there are many consumers of such data. Even more network capacity can be required when data calculated or derived from trade data is desired.

In addition, end-user tools for calculating or deriving data from trade data are generally lacking in efficiency with respect to storage and network resources. Manipulating trade data with such tools can be cumbersome and inefficient and it is frequently the case that the data desired to be calculated or derived cannot be readily obtained.

Thus, improvements related to storage and network communication of financial data and the computer-based tools used to manipulate such data are in demand.

### SUMMARY OF INVENTION

Computers, computer systems, and methods of processing a security data record set include determining a last trade yield spread and a benchmark yield spread, which may be selected, stored, or displayed over a network or at a computer.

### BRIEF DESCRIPTION OF DRAWINGS

The drawings illustrate, by way of example only, embodiments of the present disclosure.

FIG. 1 is a diagram of a networked computer system.

FIG. 2 is a block diagram of the data server.

FIG. 3 is a block diagram of the operations server.

FIG. 4 is a block diagram of one of the client computers.

FIG. 5 is a schematic diagram of a security data record set.

FIG. 6 is a flowchart of a method of processing the security data record set to obtain spread information.

FIG. 7 is a spread record data set that stores obtained spread information.

FIG. 8 is a diagram illustrating a spread calculation.

FIG. 9 is a flowchart of another method of processing a security data record set to obtain spread information.

FIG. 10 is a diagram of a chart of a security data record set for selecting an input date.

FIG. 11 is a diagram of the chart of the security data record set showing a user interface for viewing and controlling display of spread information for the input date.

FIG. 12 is a diagram of the chart of the security data record set showing another user interface for viewing and controlling display of spread information for an input date.

### DESCRIPTION OF EMBODIMENTS

Processing of financial data for securities, such as bonds, that tend not to be traded every trading day is described herein. Such processing calculates, stores, and displays spread information with techniques that can save storage space and network resources.

Computers and computer systems configured to perform such processing are also discussed, including a computerized tool for initiating such processing spread information and displaying the results in an intuitive and efficient manner.

Forms of storage- and network-efficient and highly relevant spread information, such as a last trade yield spread to benchmark in association with a current benchmark yield spread, are also discussed.

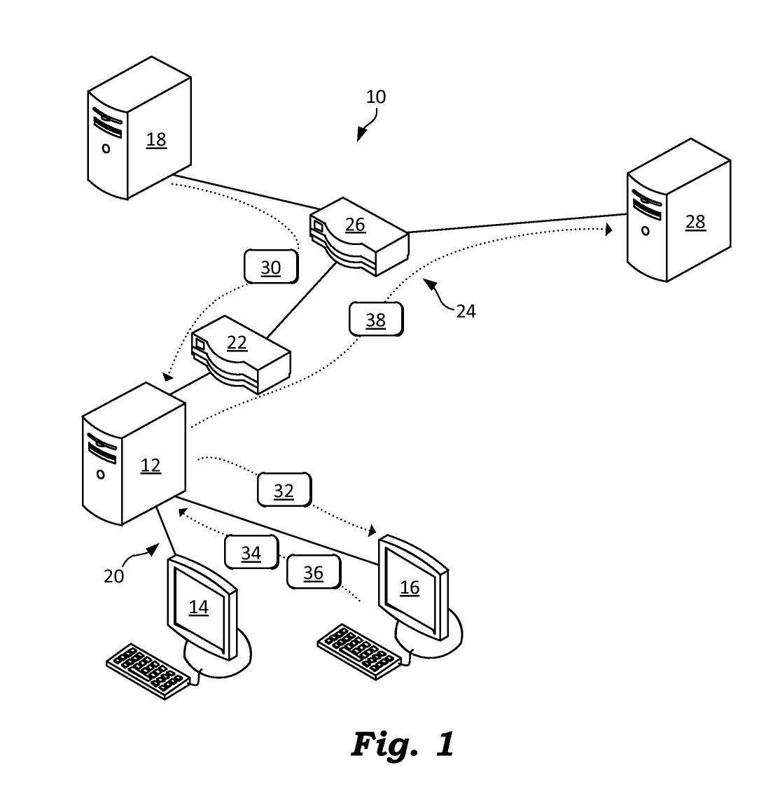

FIG. 1 illustrates a computer system 10 according to one embodiment.

The computer system 10 includes at least one computer. In this embodiment, the computer system 10 includes an operations server 12, one or more client computers 14, 16, and a data server 18. Although each of the computers described herein may be referred to in the singular, it should be understood that the same functions can be provided by several computers configured to operate together. For example, the operations server 12 is representative of one or more of such servers, which may together be known as a service.

A network, generally indicated at 20, connects the client computers 14, 16 to the operations server 12. Such a network 20 may include network devices such as hubs, routers, network cables, wireless access points, fiber-optic lines, and the like, but these are omitted from the figure for clarity and will not be discussed in detail. In one example, the network 20 may be a private intranet under the control and administration of an organization such as a corporation or institution, with the client computers 14, 16 being workstations exclusively used by individuals belonging to such organization. In another example, the network 20 may be accessible to client computers under the control and administration of different organizations, and as such the network 20 may be a public or semi-public network. That is, the server 12 may be accessible to the client computers 14, 16 using security credentials over a public network, such as the Internet. Irrespective of the specific structure of the network 20, the network 20 provides for data communication between the client computers 14, 16 and the operations server 12.

When the network 20 is implemented as a private network, the network 20 may further include a router 22 or other network device configured as a firewall. The firewall 22 connects the network 20 to external networks and restricts network traffic according to a policy.

Another network, generally indicated at 24, connects the operations server 12 to the data server 18. The network 24 includes a plurality of routers and other network devices, represented generally at 26, that provides for data communication between the data server 18, the operations server 12 and other computers. The network 24 may further include additional network devices such as hubs, routers, network cables, wireless access points, fiber-optic lines, and the like, but these are omitted from the figure for clarity and will not be discussed in detail. Data communication between the data server 18, the operations server 12, and any another computer on the network 24 may be encrypted. The network 24 can represent the Internet.

The networks 24, 20 may both be part of the same larger network, such as the Internet or a large organisation's wide-area network.

The computer system 10 may be connected via the network 24 to a trading system that includes a computer such as a trading server 28. The trading system is configured to initiate execution of automatic trades based on information received from the computer system 10.

The computer system 10 is configured to process data relevant to one or more financial securities. In this embodiment, the data server 18 is configured to send financial security data 30 to the operations server 12 via the network 24. The operations server 12 can be configured to send one or more security data record sets 32, or spread information determined therefrom, via the network 20 to the client computers 14, 16, which are configured to receive selection inputs 34, 36 from human users and to the send selection inputs 34, 36 to the operations server 12 over the network 20. The operations server 12 is configured to respond to selection inputs 34 identifying selected security data 30 by requesting such security data 30 from the data server 18. The operations server 12 may further be configured to respond to selection inputs 36 indicating trades, which can be selected on the basis of the security data record sets 32, or spread information determined therefrom, by generating trade orders 38 and by sending such trade orders 38 to the trading server 28 for fulfillment.

The computer system 10 is described and shown according to one embodiment. In another embodiment, the computer system includes the operations server 12 and the client computers 14, 16, while omitting the data server 18, which forms part of a different computer system. In another embodiment, the computer system includes the operations server 12 and data server 18, while omitting the client computers, which form part of a different computer system. In still another embodiment, the computer system includes one or more operations servers 12. In still another embodiment, the computer system includes a single computer. Irrespective of the specific makeup of the computer system, the computer system is configurable to operate as described herein with reference to the example embodiment of FIG. 1.

Referring to FIGS. 2, 3, and 4, components of the data server 18, operations server 12, and client computers 14, 16 are shown.

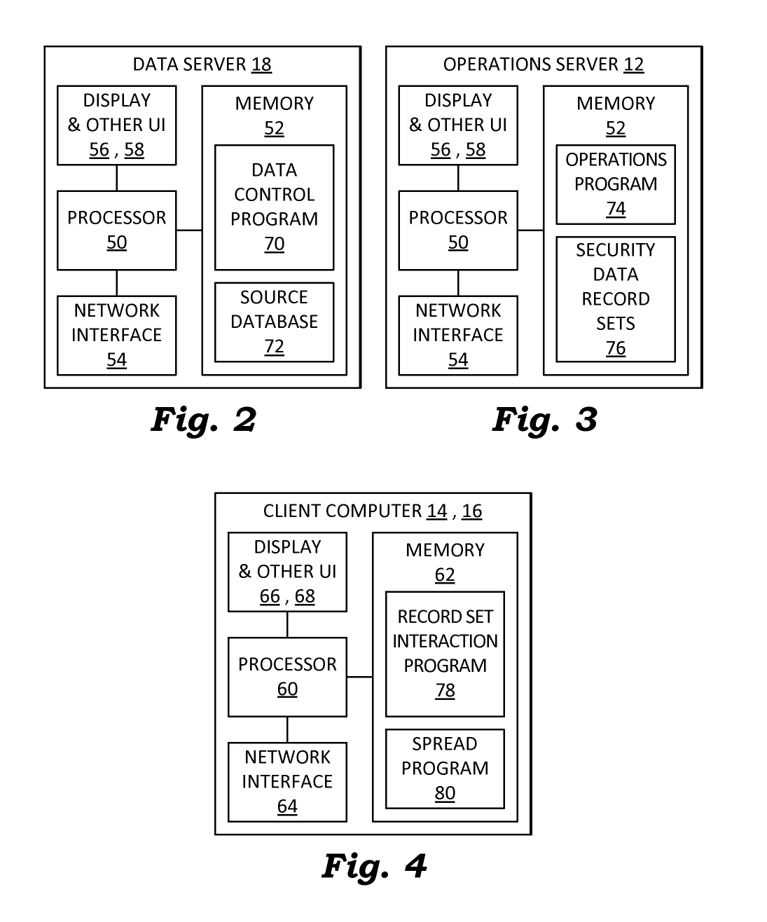

As shown in FIGS. 2 and 3, each of the data server 18 and operations server 12 includes a processor 50, memory 52, a network interface 54, and can further include a display 56 and other user interface components 58. The processor 50, memory 52, network interface 54, and display 56 and other user interface 58 are electrically interconnected and can be physically contained within a housing or frame. The servers 18, 12 may each be a computer such as a rack-mount server, blade server, tower server, or another kind of computer, or a process or program running on such a computer.

The processor 50 is configured to execute instructions, which may originate from the memory 52 or the network interface 54. The processor 50 may be known a central processing unit (CPU). The processor 50 can include one or more sub-processors or processing cores.

The memory 52 includes a non-transitory computer-readable medium that is configured to store programs and data. The memory 52 can include one or more short-term or long-term storage devices, such as a solid-state memory chip (e.g., DRAM, ROM, non-volatile flash memory), a hard drive, an optical storage disc, and similar. The memory 52 can include fixed components that are not physically removable from the server 18, 12 (e.g., fixed hard drives) as well as removable components (e.g., removable memory cards). The memory 52 allows for random access, in that programs and data may be both read and written.

The network interface 54 is configured to allow the server 18, 12 to communicate with other computers across a network. The network interface 54 can include one or more of a wired and wireless network adaptor and well as a software or firmware driver for controlling such adaptor.

The display 56 and other user interface components 58, if provided, can include a display device, such as a monitor, a bank of light-emitting diodes (LEDs), or similar for monitoring operations of the server 18, 12. The user interface 58 can include an input device, such as a keyboard, mouse, touch-sensitive element of a touch-screen display, or similar device. The user interface 58 can be remote to the server 18, 12 and provided via the network interface 54 to a client computer operated by a remote administrator.

Although the data server 18 and operations server 12 may have similar components, as described above, the data server 18 may be configured for high storage capacity (e.g., much memory 52), while the operations server 12 may be configured for high processing speed (e.g., multiple advanced processors 50).

As shown in FIG. 4, each of the client computers 14, 16 includes a processor 60, memory 62, a network interface 64, and a display 66 and other user interface components 68. The processor 60, memory 62, network interface 64, and display 66 and user interface 68 are electrically interconnected and can be physically contained within a housing or frame. The client computers 14, 16 may each be a computer such as a desktop computer, notebook computer, tablet computer, smart phone, netbook, and the like.

The processor 60 is configured to execute instructions, which may originate from the memory 62 or the network interface 64. The processor 60 may be known a CPU. The processor 60 can include one or more sub-processors or processing cores.

The memory 62 includes a non-transitory computer-readable medium that is configured to store programs and data. The memory 62 can include one or more short-term or long-term storage devices, such as a solid-state memory chip (e.g., DRAM, ROM, non-volatile flash memory), a hard drive, an optical storage disc, and similar. The memory 62 can include fixed components that are not physically removable from the client computer 14, 16 (e.g., fixed hard drives) as well as removable components (e.g., removable memory cards). The memory 62 allows for random access, in that programs and data may be both read and written.

The network interface 64 is configured to allow the client computer 14, 16 to communicate with other computers across a network. The network interface 64 can include one or more of a wired and wireless network adaptor and well as a software or firmware driver for controlling such adaptor.

The display 66 and other user interface components 68 can include a display device, such as a monitor and an input device, such as a keyboard, keypad, mouse, touch-sensitive element of a touch-screen display, or similar device.

Referring back to FIG. 2, the data server 18 includes a data control program 70 and a source database 72 stored in its memory 52. The data control program 70 includes processor-executable instructions that control input and output of data to the source database 72. For example, the source database 72 can be an SQL-compatible database, or another kind of database, and the data control program 70 can include SQL or other queries that add, modify, and delete data records from the source database 72. The source database 72 is configured to store records of financial securities trades, holdings, or other transactions, and such records may be received from another server, such as a server of a trade clearing and settlement service (e.g., CDS Clearing and Depository Services Inc. of Toronto, Canada). The source database 72 may be relatively large and thus may store data for a wide range of different types of securities, such as bonds and equities, spanning the past several years. The data control program 70 may be configured to clean, filter, or check data received from such a source. The data control program 70 is further configured to send security data 30 to the operations server 12 via the network 24 (FIG. 1).

Referring to FIG. 3, the operations server 12 includes an operations program 74 and one or more security data record sets 76 stored in its memory 52. The operations program 74 includes processor-executable instructions configured to retrieve security data record sets 76 or updates thereof from the source database 72 on the data server 18 and send security data record sets 76, portions thereof, or calculated spread data thereof to the client computers 14, 16. The operations program 74 may be responsive to selection inputs 34 (FIG. 1) of securities data received from the client computers 14, 16. The operations program 74 may be configured to select as a security data record set 76 only a portion of the security's data stored at the source database 72, such as data spanning a selected date range or data meeting certain criteria, such as trades over a predetermined face value (e.g., $500,000). The operations program 74 may further be configured to generate and send trade orders 38 (FIG. 1) to the trading server 28 based on trade requests 36 received from the client computers 14, 16.

Each of the security data record sets 76 includes data pertaining to a security of interest, as will be discussed in further detail below. Each security data record set 76 may be the result of a query performed on the source database 72 and may be stored as a query result, a database table, or as some other data or file structure. The security data record sets 76 may be stored in the memory 52 as a database (e.g., an SQL-compatible or other kind of database), which may be a synchronized copy of the entire or a portion of the source database 72 at the data server 18.

The security data record sets 76 may be stored at the operations server 12 or at the client computers 14, 16 in an encrypted database.

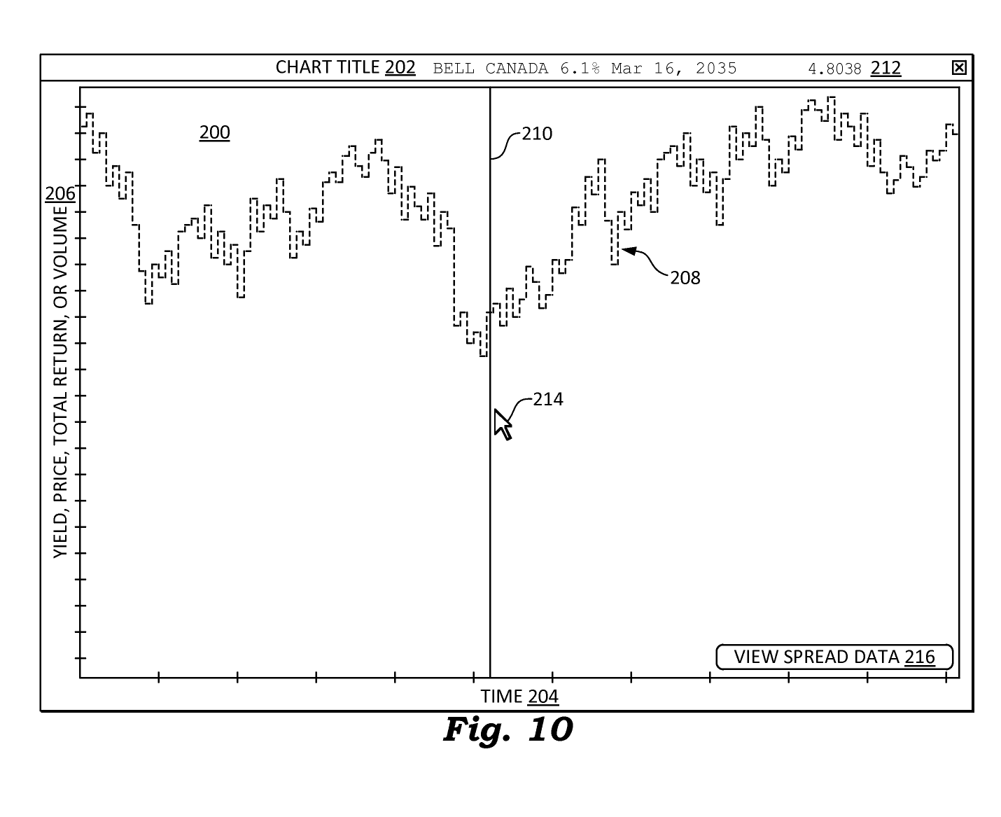

Referring to FIG. 4, each of the client computers 14, 16 includes a record set interaction program 78 and a spread program 80 stored in its memory 62. The record set interaction program 78 includes processor-executable instructions that are configured to allow user selection of security data record sets 76 at the operations server 12. That is, the record set interaction program 78 allows a client computer 14, 16 to select for output at the display 66 any of the security data record sets 76 at the operations server 12. The record set interaction program 78 is further configured to display at least a portion of the security data record set 76 at the display 66 in the form of a chart (FIG. 10), value table, or the like. If the desired record set 76 is not available at the operations server 12, then the record set interaction program 78 can request that the operations server 12 obtain the record set 76 from the data server 18. If a record set 76 is no longer needed, then the record set interaction program 78 can provide a request to the operations server 12 to delete or cease synchronization of such record set.

The spread program 80 includes processor-executable instructions that are configured to determine spreads for the security data record sets 76. In this embodiment, such spreads include a benchmark yield spread and a last trade yield spread for selected input dates that can be, for example, received at the user interface 68 of the client computer 14, 16. The operations of the spread program 80, the benchmark yield spread, and the last trade yield spread will be discussed in more detail below.

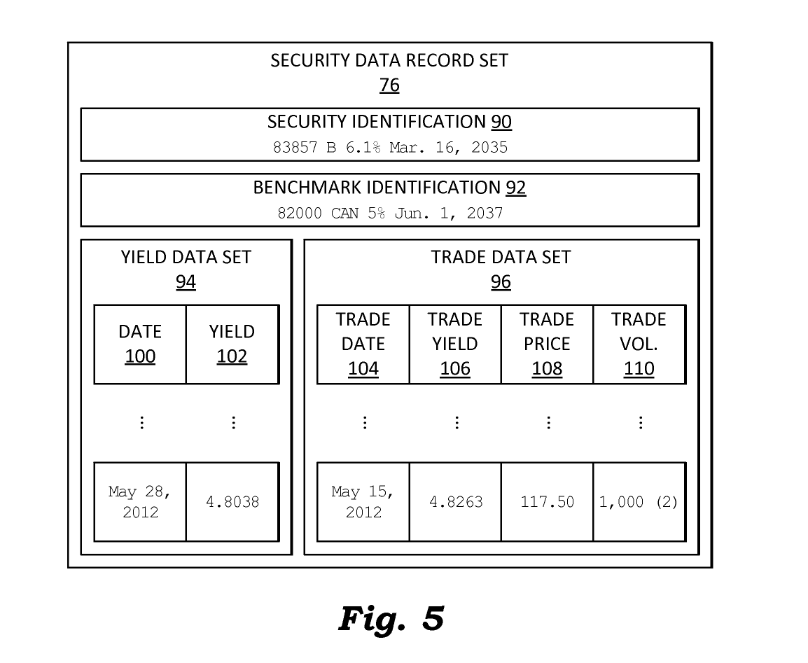

FIG. 5 shows a diagram of a data structure of a security data record set 76. The security data record set 76 includes a security identification data element 90, a benchmark identification data element 92, a yield data set 94, and a trade data set 96. The data structure of the security data record set 76 can be defined by a schema such as extensible markup language (XML) schema, one or more saved database queries (e.g., SQL or other format queries), or the like. Data elements that may be used include data fields, variables, arrays, types, classes, and similar.

The yield data set 94 and trade data set 96 cover the same general range of dates and are separated into different sets 94, 96 because the security represented by the security data record set 76 does not typically trade each trading day. That is, the yield data set 94 is typically expected to be larger than the trade data set 96. This arrangement can save storage space and communications resources when compared to a single data set that stores both yield data and trade data. However, a single data set can be used in another embodiment.

In the below description of the data elements of the data structure of a security data record set 76, example data for a bond is referenced.

The security identification data element 90 is configured to store an identification of the security data record set 76. Accordingly, the security identification data element 90 can store security identification data such as a unique identification number (e.g., “83857”) that is used as a key to reference the security in the source database 72 and in communications between computers. The security identification data element 90 can include a name or symbol (e.g., “B” or “BELL”) that represents a human-intelligible indication of the security. In the example of a bond, the security identification data element 90 can further store a coupon value (e.g., “6.1%”) and a maturity date (e.g., “Mar. 16, 2035”). The security identification data element 90 enables at least one of machine and human comprehension of the general content of the security data record set 76.

The benchmark identification data element 92 is configured to store an identification of the benchmark security record set to which the security represented by the security data record set 76 is compared. In the case of a bond, the benchmark security is typically a government issued bond. Accordingly, the benchmark identification data element 92 can store benchmark identification data such as a unique identification number (e.g., “82000”) that is used as a key to reference the benchmark security in the source data base 72 and in communications between computers. The benchmark identification data element 92 can include a name or symbol (e.g., “CAN” or “CANADA”) that represents a human-intelligible indication of the benchmark security. In the example of a bond, the benchmark identification data element 92 can further store a coupon value (e.g., “5%”) and a maturity date (e.g., “Jun. 1, 2037”). The benchmark identification data element 92 enables at least one of machine and human comprehension of the benchmark security.

The yield data set 94 is configured to store yield values (e.g., “4.8038”) for different dates (e.g., “May 28, 2012”) and accordingly includes a yield date data element 100 and a yield value data element 102 configured to store a plurality of yield values in association with a plurality of dates. The dates stored by the yield date data element 100 are generally expected to be a contiguous range of days when the market is open for trading. Each value stored by the yield data element 102 is generally expected to be an accepted or averaged yield for the associated day. In another embodiment, any one or more of price, total return, or volume may be stored in a data element similar to the yield data element 102 instead of or in addition to the yield data element 102. That is, in other embodiments, the data set 94 may store any one or more of yield, price, total return, or volume for a range of dates.

The trade data set 96 is configured to store trade yield values (e.g., “4.8263”) for different dates (e.g., “May 15, 2012”) and may further be configured to store trade prices (e.g., “117.50”) and trade volumes (e.g., “1,000 (2)”) for such dates. Accordingly, trade data set 96 includes a trade date data element 104 and a trade yield data element 106 and may further include a trade price data element 108 and a trade volume data element 110. The dates stored by the trade date data element 104 are the dates on which one or more trades of the security were made. The range of dates stored in the trade date data element 104 may be bounded by the range of dates stored in the yield date data element 100.

In this embodiment, each value stored by the trade yield data element 106 is configured as an average market-weighted yield, or other combined value, for all trades that took place on the corresponding date stored in the trade date data element 104.

Each value stored by the trade price data element 108 may be configured as an average market-weighted price, or other combined value, of all trades that took place on the corresponding date stored in the trade date data element 104. Likewise, each value stored by the trade volume data element 110 may be configured as the total volume of the trades that took place on the corresponding date stored in the trade date data element 104. In this example, the total volume is in thousands of units and the number of trades contributing to the total volume is appended in parenthesis.

The example data shown in the figure can be interpreted as follows. On May 28, 2012, the bond “B” had a yield of 4.8038 with respect to the bond “CAN”. On May 15, 2012, the same bond “B” was traded twice at a total volume of 1,000,000, with an average market-weighted price of $117.50 and an average market-weighted yield of 4.8263 with respect to the bond “CAN”.

In this embodiment, only those trades that meet the criteria of a face value of over a predetermined amount (e.g., $500,000), as selected by the operations program 74 (FIG. 3), are used to determine the average market-weighted price and yield and counted towards the total volume to be stored in the trade data set 96. This can be implemented by a calculated query or sub-query, by a procedural calculation, or similar technique performed by the operations program 74 on the source database 72 when the operations program 74 obtains or updates the security data record set 76. In other embodiments, other criteria or no criteria can be employed.

In this embodiment, the security data record set 76 omits one or more of a benchmark yield spread and last trade yield spread. Such omission can be advantageous as the size of the security data record set 76 can be kept smaller when not including such spread data. As is discussed elsewhere herein, the benchmark yield spread and the last trade yield spread are determined as needed in order to save storage space and increase network efficiency when storing and sending the security data record set 76.

Determining spread information from a security data record set 76 will now be discussed.

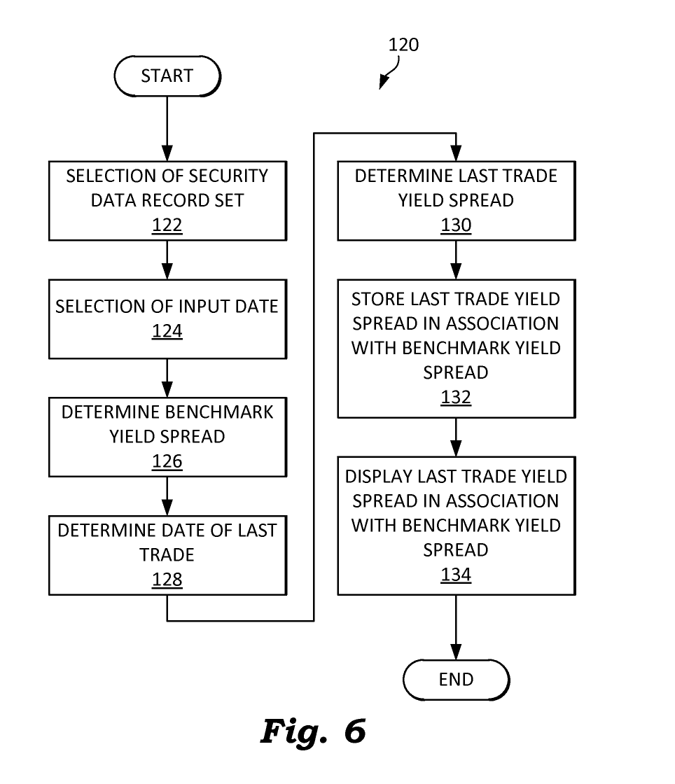

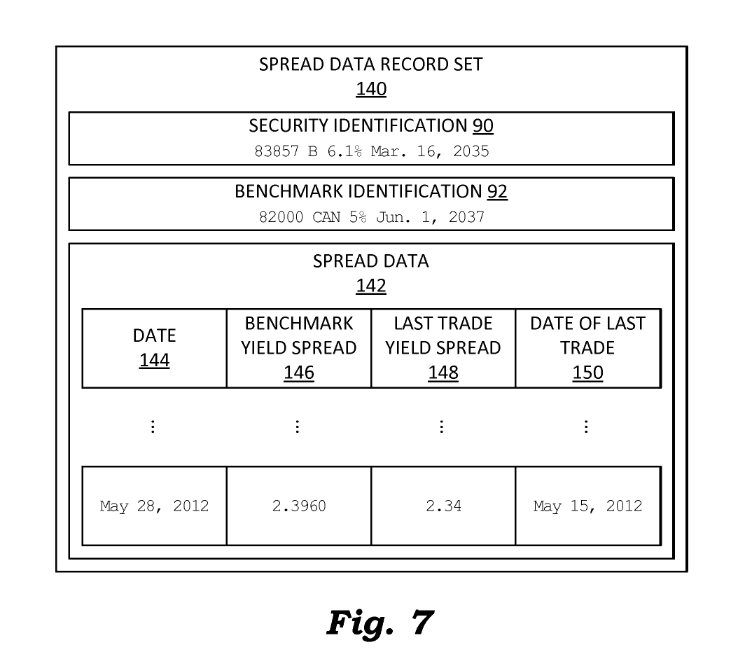

FIG. 6 illustrates a method 120 for processing a security data record set 76 to obtain spread information. The method 120 is described in terms of the computer system 10 for sake of explanation and may be performed by other computers or systems. The method 120 is also described, for explanatory purposes, as operating on a security data record set 76 of FIG. 5 to generate and output a spread record data set 140, shown in FIG. 7.

At 122, a selection of a security data record set 76 is received. This may take place at the display 66 and user interface 68 of the client computer 14, 16. For example, a list of available securities may be displayed for a user of the client computer 14, 16 to select from. In response to selection of the security data record set 76, the associated benchmark security record set can be selected automatically based on the benchmark identification data element 92 stored with the security data record set 76. The benchmark security record set can then be automatically obtained from the operations server 12 or the data server 18, if not already present.

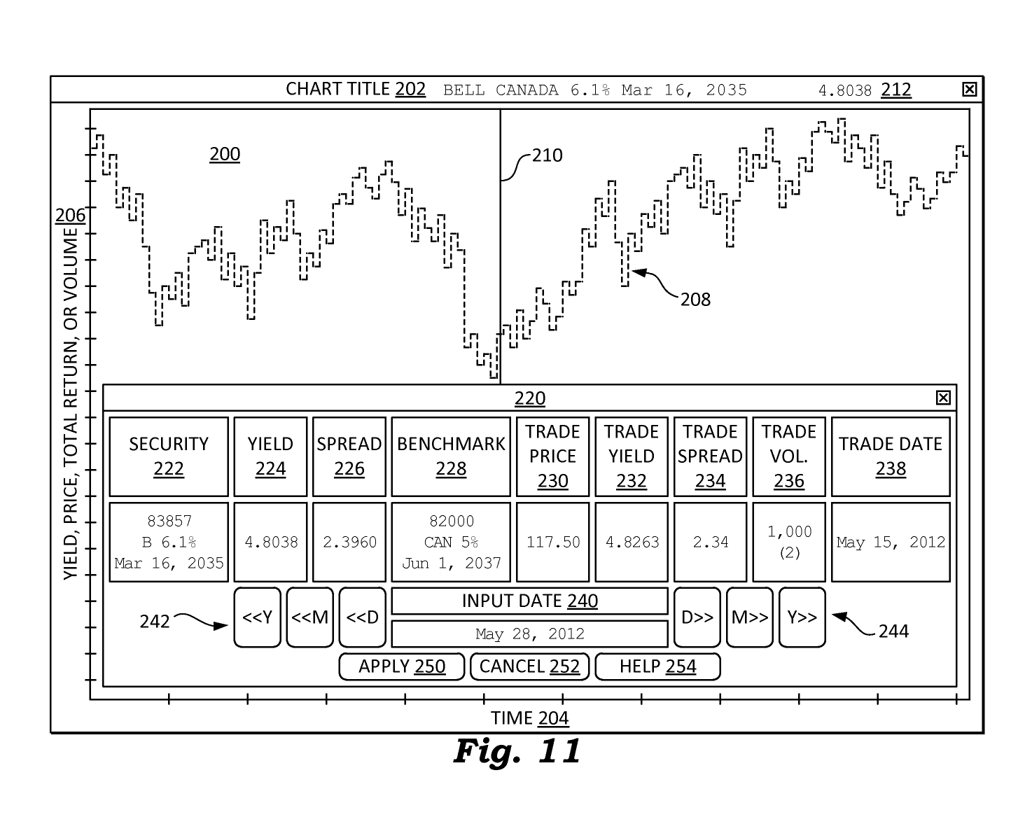

Next, at 124, selection of an input date is received. This may take place at the user interface 68 of the client computer 14, 16. For example, the user may indicate a particular date of interest. In some embodiments, more than one input date may be selected. Selection of an input date will be discussed further below in relation to FIGS. 10 and 11.

Then, at 126, a benchmark yield spread for the input date is determined from the security data record set 76 with reference to the benchmark security. For example, referring to FIG. 5, the yield data set 94 of the security data record set 76 is date-correlated to yield data of the security data record set for the benchmark security identified in the benchmark identification data element 92 to calculate the benchmark yield spread for the input date. With reference to the example bond data shown and assuming that the benchmark bond has a yield of 2.4078 on the input date, the benchmark yield spread can be calculated to be 4.8038−2.4078=2.3960. The benchmark yield spread can then be stored in a benchmark yield spread data element 146, shown in FIG. 7, in association with a date data element 144 that stores the input date, where both data elements 144, 146 form part of the spread data set 142 of the output spread record data set 140.

Referring back to FIG. 6, at 128, the security data record set 76 (FIG. 5) is referenced to determine a date of the last trade that occurred before the input date. For example, the input date is compared to dates stored in the trade date data element 104 of the security data record set 76 to determine on what date before the input date the most recent trade occurred. The date of last trade may be the previous trading day or may even be weeks or months prior to the input date. The determined date of last trade can then be stored in association with the input date in a date of last trade data element 150 (FIG. 7) of the spread data set 142 of the output spread record data set 140.

Referring to FIG. 6, at 130, a last trade yield spread is determined from the security data record set 76 with respect to the benchmark security for the date of last trade obtained at 128. The last trade yield data element 106 of the security data record set 76 is referenced for the input date to obtain the last trade yield, which is then reduced by the yield of the benchmark on the same date. In one embodiment, the closing yield of the benchmark security is subtracted from the last trade yield for the security represented by the security data record set 76. For instance, on the example date of last trade of May 15, 2012 shown in FIG. 5, the last trade yield is 4.8263. If, on this date, the benchmark security identified at data element 92 had a closing yield of 2.483, then the last trade yield spread is calculated to be 4.8263−2.483=2.3433, which can be rounded to 2.34. The determined last trade yield spread can be stored in association with the input date in a last trade yield spread data element 148 (FIG. 7) of the spread data set 142 of the output spread record data set 140. In other embodiments, a bid, ask, or mid-market yield of the benchmark security is used.

At 132, the last trade yield spread determined at 130 can be stored in association with the benchmark yield spread determined at 126. This can be achieved, for example, by the output spread record data set 140 (FIG. 7) or a portion thereof, such as the spread data set 142 or even simply the values of two associated data elements 146, 148, being stored in a memory 52, 62 of any one or more of the servers 12, 18 and client computers 14, 16 shown in FIGS. 2-4.

At 134, the last trade yield spread determined at 130 can be displayed in association with the benchmark yield spread determined at 126. The displaying of such can be performed at the display 66 of the client computer 14, 16. In addition, any one or more of the input date, the date of last trade, the identification of the security data record set, the yield for the input date, the identification of the benchmark security, the last trade price, the last trade yield, and the last trade volume may be displayed in association with the last trade yield spread and the benchmark yield spread. In one embodiment, the output spread record data set 140 is displayed substantially as illustrated in FIG. 7.

The method 120 may be implemented in one or more of the operations program 74, record set interaction program 78, and spread program 80 as executed by one or more of the operations server 12 and the client computers 14, 16.

In other embodiment, the steps of the method 120 may be performed in orders different from that described, any step may be broken into smaller sub-steps, and any two or more steps may be combined into a larger step.

FIG. 7 shows the spread data 142 determined as described above and stored in a spread data record set 140 data structure. The spread data 142 need only be stored for the duration that it is to be referenced. For example, the spread data 142 can be deleted when the source security data record set 76 is no longer being viewed or referenced. In another example, the spread data 142 can be limited to a predetermined size, such as ten or three or one data record, where a newly determined spread causes the oldest spread to be discarded. These examples advantageously limit the demands on memory.

The data structure of the spread data record set 140 can be defined by a schema such as extensible markup language (XML) schema, one or more database tables, or the like. Data elements that may be used include data fields, variables, arrays, types, classes, and similar.

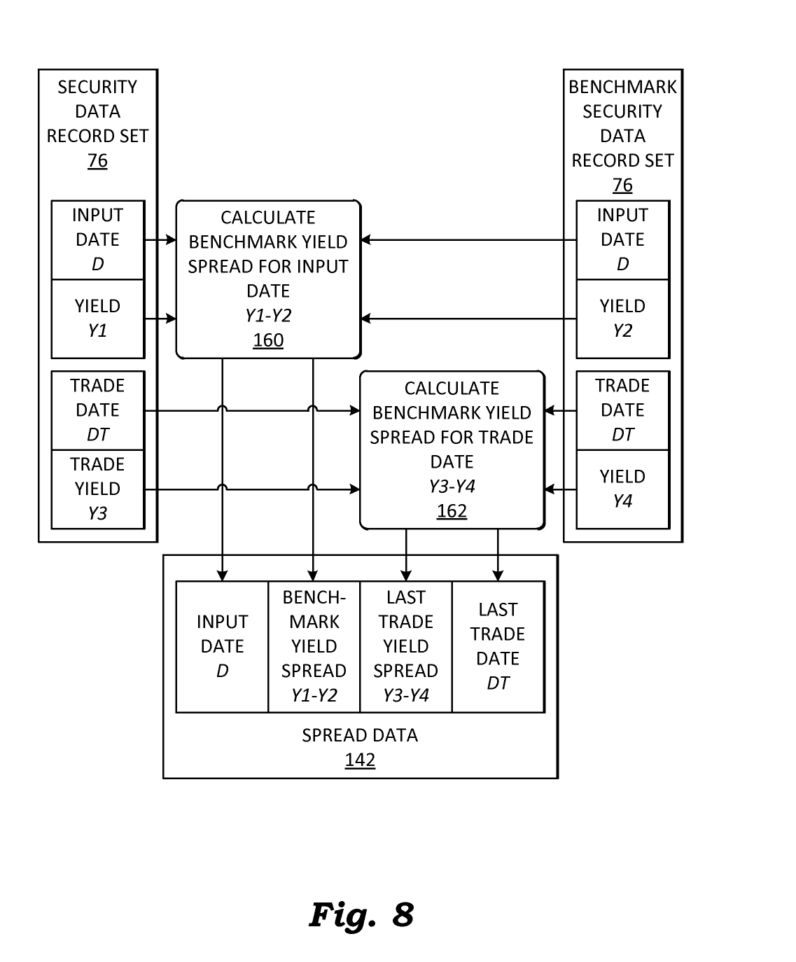

FIG. 8 is a schematic diagram illustrating calculation of the spread data set 142 shown in FIG. 7. Variable designations for the various data elements are used to aid understanding. Record sets 76 for the selected security and the benchmark security are referenced. The yields of both the selected security and the benchmark security are obtained for the input date D, and then, as indicated at 160, a benchmark yield spread Y1-Y2 is calculated for the input date D by subtracting the benchmark yield Y2 for the input date D from the selected security's yield Y1 for the input date D. The last trade yield Y3 for the date of last trade DT with reference to the input date D is obtained as well as the benchmark yield Y4 for same day DT, and then, as indicated at 162, a last trade benchmark yield spread Y3-Y4 is calculated by subtracting the benchmark yield Y4 for the date of last trade DT from the selected security's last trade yield Y3.

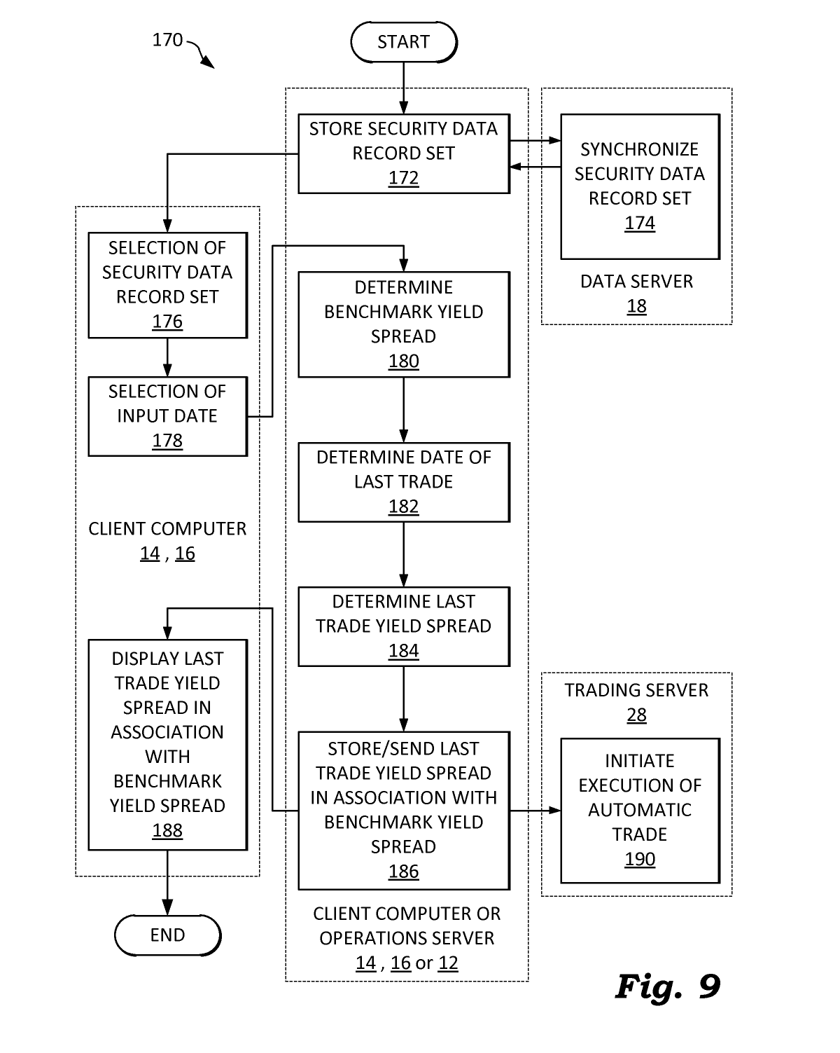

FIG. 9 shows another method 170 of processing a security data record set. The method 170 is described in terms of the computer system 10 for sake of explanation and may be performed by other computers or systems. The method 170 is also described, for explanatory purposes, as operating on a security data record set 76 of FIG. 5 to generate and output a spread record data set 140, shown in FIG. 7. Features and aspects of the method 120 of FIG. 6 may be used with the method 170.

The method 170 may be implemented at one or more of the data control program 70, operations program 74, record set interaction program 78, and spread program 80 executed by one or more of the data server 18, the operations server 12, and the client computers 14, 16. FIG. 9 illustrates by way of dashed lines which of the computers 12, 14, 16, 18, and thus which of the programs, perform which parts of the method 170.

At 172, one or more security data record sets 76 are stored at the operations server 12 or one of the client computers 14, 16. Such security data record sets 76 may correspond to securities of interest and their benchmark securities.

The security data record sets 76 stored at the operations server 12 or the client computer 14, 16 are synchronized over the network 24, at 174, with the source database 72 stored at the data server 18 according to a predetermined schedule. Synchronization can include sending new or updated records from the source database 72 to the security data record sets 76 to ensure that recent trades or other changes in the source database 72 are reflected in the security data record sets 76. Synchronizing may also include deleting old data from the security data record sets 76 as new data is added so as to advantageously limit the size of the data to a predetermined window, such as one year, to save storage space on the operations server 12 or the client computer 14, 16. The predetermined schedule for synchronization can be every few minutes, every hour, several times a day, once at the end of the trading day, or similar.

Next, at 176, selection of a security data record set 76 is made at a client computer 14, 16. For example, a user of the client computer 14, 16 may be interested in analysing a particular security. Once the security data record set 76 is selected, a chart, such as that shown in FIG. 10, may be shown at the client computer 14, 16. In response to selection of the security data record set 76, the associated benchmark security record set can be selected automatically based on the benchmark identification data element 92 stored with the security data record set 76. The benchmark security record set can then be automatically obtained from the operations server 12 or the data server 18, if not already present.

At 178, a selection of an input date is made at the client computer 14, 16. The selection can be made using any of the techniques described herein, such as by way of the value line of FIGS. 10 and 11.

Then, the benchmark yield spread is determined at 180, the date of last trade is determined at 182, and the last trade yield spread is determined at 184 using the techniques described elsewhere herein, such as described with respect to FIGS. 6-8. In one embodiment, these determinations are made at the operations server 12, while in another embodiment, these determinations are made at the client computer 14, 16. An advantage of making these determinations at the operations server 12 is that processing resources of the client computer 14, 16 can be saved for other tasks. An advantage of making these determinations at the same computer 12, 14, 16 that stores the security data record set 76 is that data transmitted over the network 20 (FIG. 1) can be reduced. That is, when the security data record set 76 is stored on the operations server 12 and these determinations are also made on the operations server 12, the client computer 14, 16 need only send the input date to the operations server 12.

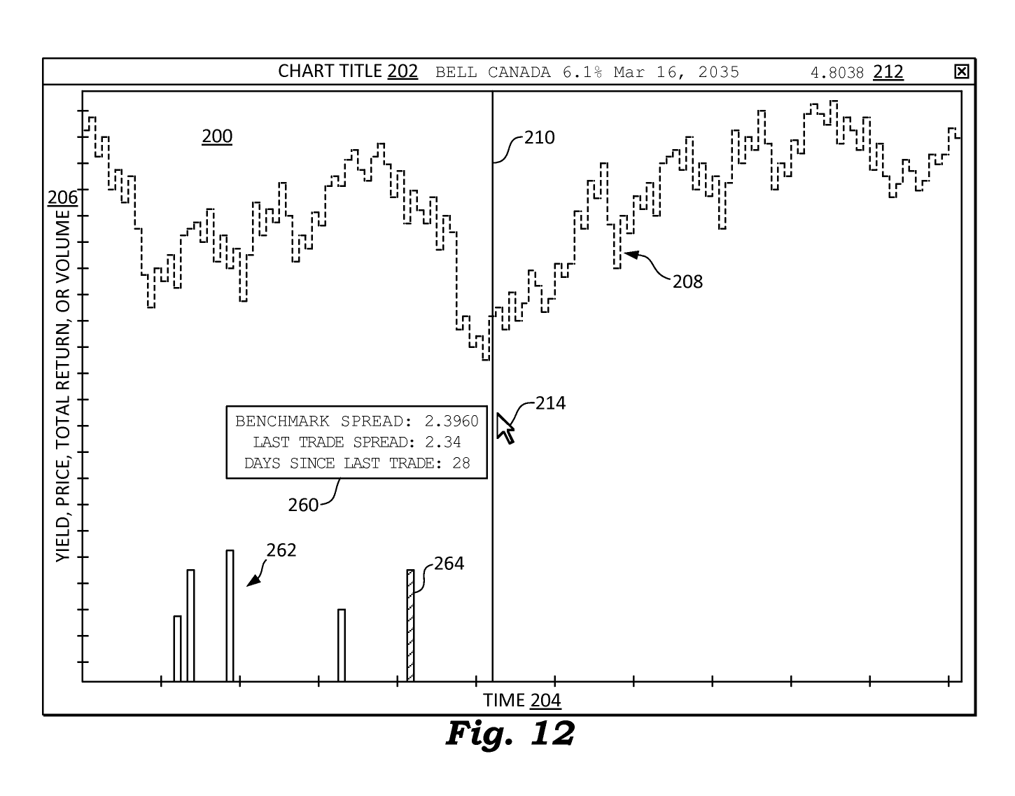

At 186, the determined last trade yield spread is stored in association with the determined benchmark yield spread. Additionally or alternatively, when the operations server 12 is configured to perform 186, the determined last trade yield spread and associated determined benchmark yield spread can be sent over the network 20 to the client computer 14, 16 that originally sent the input date. The last trade yield spread and associated benchmark yield spread can then be displayed, at 188, at the client computer 14, 16 by way of, for example, the window and chart shown in FIG. 11 or 12. Further additionally or alternatively, a trade order 38 (FIG. 1) can be generated referencing the determined last trade yield spread and associated benchmark yield spread, and the trade order 38 can be sent over the network 24 to the trading server 28 to initiate execution of an automatic trade, at 190.

As can be seen, FIG. 9 describes at least seven embodiments: a first embodiment in which the client computer 14, 16 performs 176, 178, 188 and the operations server 12 performs 172, 180-184, 186; a second embodiment in which the client computer 14, 16 performs 172, 176, 178, 188 and the operations server 12 performs 180-184, 186; a third embodiment in which the client computer 14, 16 performs 176, 178, 180-184, 188 and the operations server 12 performs 172, 186; a fourth embodiment in which the client computer 14, 16 performs 176, 178, 186, 188 and the operations server 12 performs 172, 180-184; a fifth embodiment in which the client computer 14, 16 performs 172, 176, 178, 180-184, 188 and the operations server 12 performs 186; a sixth embodiment in which the client computer 14, 16 performs 176, 178, 180-184, 186, 188 and the operations server 12 performs 172; and a seventh embodiment in which the client computer 14, 16 performs 172, 176, 178, 180-184, 186, 188 and the operations server 12 is not needed.

In other embodiment, the steps of the method 120 may be performed in orders different from that described, any step may be broken into smaller sub-steps, and any two or more steps may be combined into a larger step.

FIG. 10 illustrates a chart 200 displaying at least a portion of a security data record set, such as the security data record set 76 of FIG. 5. The chart 200 can be displayed on a display 66 of a client computer 14, 16 as output of the record set interaction program 78, discussed with respect to FIG. 4.

The chart 200 includes a title 202, which can include information regarding the security data record set 76, such as the security identification 90 (FIG. 5).

A time scale 204 can be provided on the x-axis of the chart 200 in units of time, such as days, weeks, months, or years. A value scale 206 can be provided on the y-axis of the chart 200 in units of value, such as yield, price, total return, or volume. In other embodiments, multiple different value scales can be provided so that more than one of yield, price, total return, and volume can be displayed at the same time in a composite overlay or in separate panes or windows.

The plotted data 208 shown on the chart 200 can be data stored in the data set 94 of the security data record set 76 of FIG. 5. In this example, the data set 94 is a yield data set 94 and the chart plots yield vs. time.

A movable value line 210 is a control that can be provided to the chart 200 to receive selection of an input date. The value (e.g., “4.8038”) of the security data record set 76 at the value line 210 (i.e., on the input date selected by the value line 210) can be displayed numerically on the chart 200, such as in the title bar at 212. The value line 210 is positionable on the chart 200 by way of the user interface 68 (FIG. 4) of the client computer 14, 16 that displays the chart 200. The user interface 68 can be configured to receive user manipulation of the value line 210 by, for example, the record set interaction program 78. For example, the value line 210 can be hidden or shown by way of a mouse click, a menu selection, a press of a key of a keyboard, taps on a touch-screen, or similar input. Likewise, the value line 210 can be moved left (towards older dates) and right (towards more recent dates) by way of mouse movement, presses of keys of a keyboard, drags or swipes on a touch-screen, or similar input. Such inputs are generally represented by the mouse pointer 214 for sake of simplicity.

Further provided to the chart 200 is a control, such as a button 216, that can be tapped or mouse-clicked to trigger display of spread data for the chart 200. The button 216 can also trigger the calculation of the spread data for the input date indicated by the value line 210, which advantageously relieves the processor 60 of the client computer 14, 16 from having to calculate all possible spread data in advance, thereby saving resources of the client computer 14, 16 for other tasks. In other words, the user triggering the control 216 can trigger just-in-time determination and display of spread data for the security data record set 76 shown in the chart 200.

Other controls for triggering display of spread data for the chart 200 can be provided in addition to or alternatively to the button 216, including a double-click or double-tap, a right click, a menu item, a context menu item, a toolbar button, and the like.

FIG. 11 illustrates the chart 200 overlaid by a window or other user interface element 220 displaying data relevant to the value line 210, including spread data. The window 220 can be configured to appear in response to the pressing of the button 216 or other control described with respect to FIG. 10.

The window 220 can include display elements corresponding to the source data elements 100-110 of the security data record set 76 shown in FIG. 5 and the calculated or processed data elements 144-150 of the spread data record set 140 shown in FIG. 7. Specifically, the window 220 can include a security identification display element 222 linked to the security identification data element 90, a yield display element 224 linked to the yield data element 102, a benchmark yield spread display element 226 linked to the benchmark yield spread data element 146, a benchmark identification display element 228 linked to the benchmark identification data element 92, a trade price display element 230 linked to the trade price data element 108, a trade yield display element 232 linked to the trade yield data element 106, a last trade yield spread display element 234 linked to the last trade yield spread data element 148, a trade volume display element 236 linked to the trade volume data element 110, and a trade date display element 238 linked to the trade date data element 104. The window 220 may further include a textual control 240 for receiving selection of an input date, with such control 240 being linked to the date data element 100 or 144.

The display elements 222-238 and input date control 240 are configured to display the values of the linked data elements 100-110 and 144-150 corresponding to the input date selected at the control 240. In particular, the display and control elements of the window 220 are configured to display at least the last trade yield spread in visual association with the benchmark yield spread at the selected input date. The display elements 222-238 can include textbox controls or similar, with appropriate labels. The input date control 240 may be a textbox control, which may trigger display of a mini-calendar to permit selection of the input date.

The window 220 can include controls, such as buttons 242, 244, that when pressed change a previously selected date to the input date. That is, the buttons 242 can be pressed to decrement the input date by various amounts, such as one day, one month, and one year, with each amount being assigned to a specific button 242. Likewise, the buttons 244 can be pressed to increment the input date by various amounts, such as one day, one month, and one year, with each amount being assigned to a specific button 244.

Each of the value line 210, the textual control 240, and the buttons 242, 244 is a control that can be configured to trigger calculation of the benchmark yield spread and last trade yield spread in response to receiving selection of the input date, such that the content of the display elements 222-238 are updated as the input date changes. Each of the value line 210, the textual control 240, and the buttons 242, 244 can be provided independent of the others. For example, in another embodiment, only the value line 210 is provided. In still another embodiment, only the textual control 240 is provided. In yet another embodiment, the value line 210 and buttons 242, 244 are provided with the input control 240 being excluded. All such combinations are contemplated.

The window 220 may further include controls, such as buttons 250, 252, 254, configured to control additional operations. An “apply” button 250 can be configured to trigger calculations to be performed referencing a newly selected input date, if such calculations are not configured to occur automatically when such input date is selected. A “cancel” button 252 is configured to close the window 220 while either leaving the value line 210 at a newly selected input date or returning the value line 210 to a previously selected input date based on user preference. Lastly, a “help” button 254 may be provided to display helpful information to the user regarding the window 220 when pressed.

FIG. 12 illustrates the chart 200 showing yield information according to another embodiment. Features and aspects of this embodiment can be used with the other embodiments described herein and vice versa.

A textual display element 260, such as a textbox, is provided with output, for the input date, of the benchmark yield spread from the benchmark yield spread data element 146 (FIG. 7) and the last trade yield spread from the last trade yield spread data element 148, in response to receiving selection of the input date via the value line 210. Also shown is an indication of the number of days since the last trade, which can be calculated by subtracting the date of last trade from the input date.

Past trades are also shown at 262 and these can be plotted on a difference scale 206, in an overlay, in a different pane, or in a different window. The trade data set 96 of the security data record set 76 is referenced to plot the past trades. The last trade 264 with reference to the input date indicated by the value line 210 can be visually highlighted by an indicator, such as the hatching shown or by use of distinguishing color, an icon, or other visual accoutrement.

A textual display element 260 can move with the value line 210 or be stationary.

Additional data can be displayed in the textual display element 260, such as date of last trade, last trade price, or any of the other data described herein.

As can be seen from the above, computers, computer systems, and methods of processing a security data record set by determining a last trade yield spread and a benchmark yield spread can save storage and network resources. Such spread information can be efficiently selected, stored, or displayed over a network or at a computer. A value line, or similar control, allows for intuitive selection of an input date that forms the basis for the determination of the last trade yield spread and benchmark yield spread. Moreover, the last trade yield spread and benchmark yield spread are advantageously displayed in association with each other to provide the viewer with a quick and intuitive grasp of the relatively complex security data record set.

While the foregoing provides certain non-limiting example embodiments, it should be understood that combinations, subsets, and variations of the foregoing are contemplated. The monopoly sought is defined by the claims.

1. A method comprising:
receiving selection of a security data record set;
receiving selection of an input date from dates within the security data record set;
determining for the input date a benchmark yield spread of the security data record set with reference to a benchmark security record set;
determining from the security data record set a date of last trade that occurred before the input date;
determining for the date of last trade a last trade yield spread of the security data record set with reference to the benchmark security record set; and
storing the last trade yield spread in association with the benchmark yield spread.

2. The method of claim 1 further comprising:
storing the security data record set at a computer; and
synchronizing over a network the security data record set with a source database stored on a data server.

3. The method of claim 2, wherein receiving selection of the input date is performed at the computer.

4. The method of claim 3, wherein determining the benchmark yield spread, determining the date of last trade, and determining the last trade yield spread are performed at the computer.

5. The method of claim 4 further comprising displaying the last trade yield spread in association with the benchmark yield spread.

6. The method of claim 5 further comprising displaying the input date and the date of last trade.

7. The method of claim 6 further comprising displaying in association with the last trade yield spread and the benchmark yield spread an identification of the security data record set, a yield for the input date, an identification of the benchmark security record set, a last trade price, a last trade yield, and a last trade volume.

8. The method of claim 1 further comprising sending the last trade yield spread in association with the benchmark yield spread over a network to a computer.

9. The method of claim 8, wherein the security data record set omits the benchmark yield spread and wherein determining the benchmark yield spread comprises calculating the benchmark yield spread in response to receiving selection of the input date.

10. The method of claim 9, wherein the security data record set omits the last trade yield spread and wherein determining the last trade yield spread comprises calculating the last trade yield spread in response to receiving selection of the input date.

11. The method of claim 10 further comprising displaying a chart of at least a portion of the security data record set and receiving selection of the input date at the chart.

12. The method of claim 11, wherein receiving selection of the input date comprises receiving user manipulation of a value line of the chart.

13. The method of claim 12 further comprising displaying the last trade yield spread in association with the benchmark yield spread on the chart.

14. The method of claim 11, wherein receiving selection of the input date comprises receiving entry of the input date at a textual control.

15. The method of claim 11, wherein receiving selection of the input date comprises receiving a press of a button that changes a previously selected date to the input date.

16. The method of claim 15, wherein the security is a bond and the benchmark security is a benchmark bond.

17. A non-transitory computer-readable medium storing processor-executable instructions that when executed perform a method comprising:
receiving selection of a security data record set;
receiving selection of an input date from dates within the security data record set;
determining for the input date a benchmark yield spread of the security data record set with reference to a benchmark security record set;
determining from the security data record set a date of last trade that occurred before the input date;
determining for the date of last trade a last trade yield spread of the security data record set with reference to the benchmark security record set; and
storing the last trade yield spread in association with the benchmark yield spread.

18. A computer system comprising:
at least one computer configured to:
receive selection of a security data record set;
receive selection of an input date from dates within the security data record set;
determine for the input date a benchmark yield spread of the security data record set with reference to a benchmark security record set;
determine from the security data record set a date of last trade that occurred before the input date; and
determine for the date of last trade a last trade yield spread of the security data record set with reference to the benchmark security record set.

19. The computer system of claim 18, wherein the at least one computer comprises a client computer configured to receive selection of the security data record set, receive selection of the input date, determine the benchmark yield spread, determine the last trade yield spread, and display the last trade yield spread in association with the benchmark yield spread.

20. The computer system of claim 18, wherein the at least one computer comprises:
a client computer configured to receive selection of the security data record set and receive selection of the input date; and
an operations server coupled to the client computer over a network and configured to determine the benchmark yield spread and determine the last trade yield spread;
the client computer further configured to display the last trade yield spread in association with the benchmark yield spread.

21. The computer system of claim 20, wherein the at least one computer further comprises a data server, the at least one computer further configured to synchronize over a network the security data record set with a source database stored on the data server.

22. The computer system of claim 21, wherein the security data record set omits the benchmark yield spread and wherein the at least one computer is further configured to determine the benchmark yield spread by calculating the benchmark yield spread in response to receiving selection of the input date.

23. The computer system of claim 22, wherein the security data record set omits the last trade yield spread and wherein the at least one computer is further configured to determine the last trade yield spread by calculating the last trade yield spread in response to receiving selection of the input date.

24. The computer system of claim 23, wherein the at least one computer is further configured to display a chart of at least a portion of the security data record set and receive selection of the input date at the chart.

25. The computer system of claim 24, wherein the at least one computer is further configured to receive selection of the input date by receiving user manipulation of a value line of the chart.

26. The computer system of claim 25, wherein the at least one computer is further configured to display the last trade yield spread in association with the benchmark yield spread on the chart.

27. The computer system of claim 24, wherein the at least one computer is configured to receive selection of the input date by receiving entry of the input date at a textual control.

28. The computer system of claim 24, wherein the at least one computer is configured to receive selection of the input date by receiving a press of a button that changes a previously selected date to the input date.

29. The computer system of claim 28, wherein the security is a bond and the benchmark security is a benchmark bond.
